(19) United States
(12) Patent Application Publication
(10) Pub. No.: US 2005/0267998 A1
(43) Pub. Date: Dec. 1, 2005

(54) Interchangeable communication modules for work machines

(76) Inventors: Alan Lewis Ferguson, Peoria, IL (US); Trent Ray Meiss, Eureka, IL (US); Brian Lane Jenkins, Washington, IL (US); Steven Wayne O'Neal, Bartonville, IL (US); Daniel Craig Wood, East Peoria, IL (US)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/854,817

(22) Filed: May 27, 2004

(51) Int. Cl. G06F 9/445

(52) U.S. Cl. 710/8

(57) ABSTRACT

A system and method for utilizing interchangeable communication modules includes a work machine having an interface module for connecting a plurality of communication modules. An interface control system, including an electronic component connected to the interface module, detects the connection of at least one of the plurality of communication modules and loads a software driver for operating the at least one of the plurality of communication modules.

### FIELD OF THE INVENTION

The disclosure relates generally to plug and play technology, and more particularly to systems and methods for providing interchangeable communication modules in a work machine component.

### BACKGROUND OF THE INVENTION

An important feature in modern work machines (e.g., fixed and mobile commercial machines, such as construction machines, fixed engine systems, marine-based machines, etc.) is the on-board network and associated machine control modules. An on-board network includes many different modules connected to various types of communication links. These links may be proprietary and non-proprietary, such as manufacturer-based data links and communication paths based on known industry standards (e.g., J1939, RS232, RP 1210, RS-422, RS-485, MODBUS, CAN, etc.). A machine control module may monitor and/or control one or more components of the work machine. The control module may also receive data from and transmit data to external systems. The data may be received from or transmitted to one or more components of the work machine.

To receive data from and transmit data to external systems, on-board machine components may communicate with a communication module. Most current on-board systems include a communication module with an associated software driver. However, for a given environment, the communication module that is provided may not be the most efficient communications means, both from a communications rate and cost stand point. In such an instance, the communications module provided may contribute to inefficient system operation.

To address these concerns, conventional systems began to incorporate portable radio systems. One such system is disclosed in U.S. Pat. No. 5,809,432 (“the '432 patent”), which discloses a portable radio apparatus including an apparatus body and a removable radio system unit that is detachably connected to the apparatus body. The removable radio system unit stores protocol specifying information which is transferred to the apparatus body when connected. A processor of the apparatus body controls the whole operation of the radio apparatus based on a protocol data set specified by the protocol specifying information received from the radio system unit. The protocol data set may be stored in the removable radio system. Alternatively, the apparatus body stores a plurality of protocol data sets and selects one of the protocol data sets according to the protocol specifying information.

Although the system described in the '432 patent allows a machine to use different radio systems, the '432 patent does not disclose a communication module that is installed within a work machine. Instead, the '432 discloses a portable radio apparatus that does not include means for determining which of a plurality of communication modules is the most efficient to use in a particular environment. The '432 patent also does not disclose a means for receiving the software driver from an external source if it is not available from the communication module or an electronic component stored in the interface control module.

Methods, systems, and articles of manufacture consistent with certain disclosed embodiments may solve one or more of the problems set forth above.

### SUMMARY OF THE INVENTION

A system and method are provided to perform a process for interchanging communication modules in a work machine. In one embodiment, the process includes connecting an interface module of a work machine to a plurality of communication modules. The interface module is further connected to an electronic component of an interface control system. Once the electronic component detects the connection of at least one of the plurality of communication modules, the electronic component loads the software driver for operating at least one of the plurality of communication modules.

In another embodiment, a system for utilizing interchangeable communication modules includes a work machine, including an interface module for connecting a plurality of communication modules. The interface module is further connected to an electronic component that detects the connection of at least one of the plurality of communication modules, and loads a software driver for operating at least one of the plurality of communication modules.

### BRIEF DESCRIPTION OF THE DRAWINGS

The accompanying drawings, which are incorporated in and constitute a part of this specification, illustrate several embodiments and together with the description, serve to explain the principles of the disclosed communication system. In the drawings:

FIG. 1 illustrates a block diagram of an exemplary system that may be configured to perform certain functions consistent with certain disclosed embodiments;

FIG. 2 illustrates a block diagram including further exemplary components of the exemplary system of FIG. 1;

FIG. 3 illustrates a block diagram of exemplary components of an electronic component consistent with certain disclosed embodiments; and

FIG. 4 illustrates a flow chart of an exemplary plug and play communication process consistent with certain disclosed embodiments.

### DETAILED DESCRIPTION

Reference will now be made in detail to exemplary embodiments, which are illustrated in the accompanying drawings. Wherever possible, the same reference numbers will be used throughout the drawings to refer to the same or like parts.

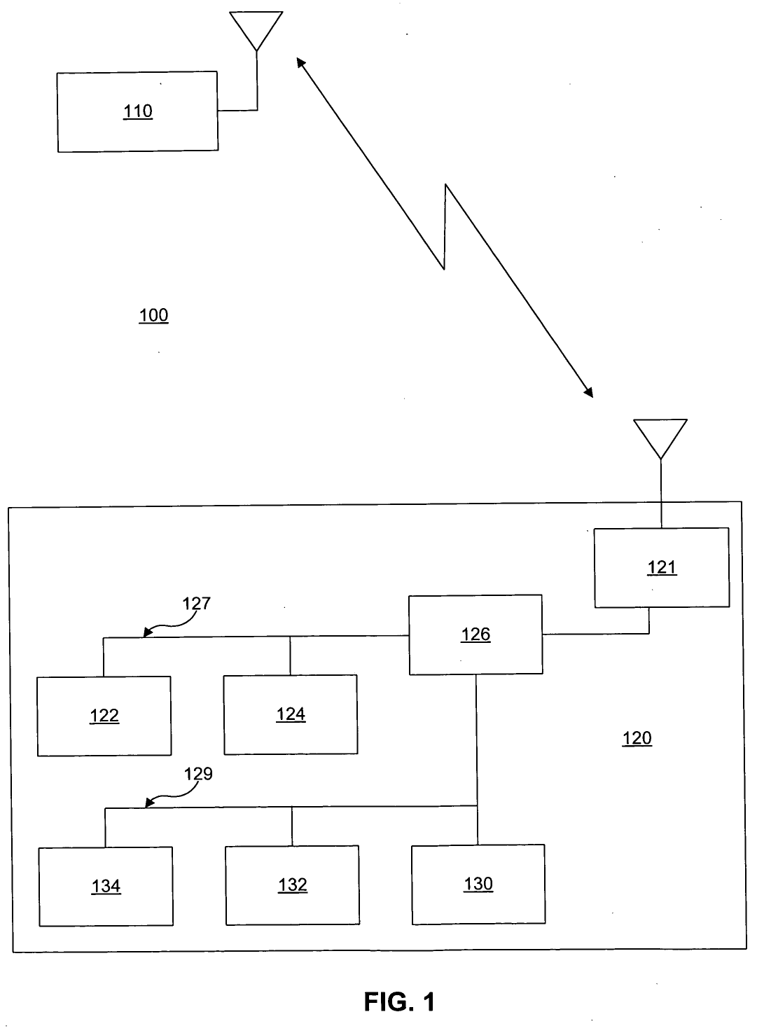

FIG. 1 illustrates an exemplary system 100 in which features and principles consistent with certain disclosed embodiments may be implemented. As shown in FIG. 1, system 100 includes a remote off-board system 110 and a work machine 120 including a communication module 121, an interface control system 126, and on-board modules 122, 124, 130, 132, and 134, respectively connected to primary and secondary on-board data links 127 and 129. Although interface control system 126 is shown as a separate entity, some embodiments may allow control system 126 to be included as a functional component of one or more of on-board modules (122-134). Further, although only a specific number of on-board control modules are shown, work machine 120 may include any number of such modules.

Work machine, as the term is used herein, refers to a fixed or mobile machine that performs some type of operation associated with a particular industry, such as mining, construction, farming, etc. and operates between or within work environments (e.g., construction site, mine site, power plants, etc.). A non-limiting example of a fixed machine includes an engine system operating in a plant or off-shore environment (e.g., off-shore drilling platform). Non-limiting examples of mobile machines include commercial machines, such as trucks, cranes, earth moving vehicles, mining vehicles, backhoes, material handling equipment, farming equipment, marine vessels, aircraft, and any type of movable machine that operates in a work environment.

An on-board module, as the term is used herein, may represent any type of component operating in a work machine that controls or is controlled by other components or sub-components. For example, an on-board module may be an operator display device, an Engine Control Module (ECM), a power system control module, a Global Positioning System (GPS) interface device, an attachment interface that connects one or more sub-components, and any other type of device that work machine 120 may use to facilitate operations of the machine during run time or non-run time conditions (i.e., machine engine running or not running, respectively).

An off-board system, as the term is used herein, may represent a system that is located remote from work machine 120, such as remote off-board system 110. An off-board system may be a system that connects to work machine 120 through wireline or wireless data links. Further, an off-board system may be a computer system including known computing components, such as one or more processors, software, display, and interface devices that operate collectively to perform one or more processes. Alternatively, or additionally, an off-board system may include one or more communications devices that facilitates the transmission of data to and from work machine 120. In certain embodiments, an off-board system may be another work machine remotely located from work machine 120.

Communication module 121 represents one or more devices that is configured to facilitate communications between work machine 120 and an off-board system, such as remote off-board system 110. Communication module 121 may include hardware and/or software that enables the module to send and/or receive data messages through wireline or wireless communications. As shown in FIG. 1, communication module 121 includes one or more wireless antennae for facilitating wireless communications with remote off-board system 110, although other off-board systems may send and receive data messages to and from communication module 121. The wireless communications may include satellite, cellular, infrared, and any other type of wireless communications that enables work machine 120 to wirelessly exchange information with an off-board system.

Modules 122 and 124 represent one or more on-board modules connected to a primary data link 127 included in work machine 120. Primary data link may represent a proprietary or non-proprietary data link, such as Society of Automotive Engineers (SAE) standard data link including Controller Area Network (CAN), J1939, etc. Primary data link 127 may be wireless or wired. For example, in one embodiment, work machine 120 may include wireless sensors that are linked together through interface control system 126. The term “primary data link” is not intended to be limiting. That is, “primary” refers to a data link for designation purposes only, and does not infer primary functionality associated with the data link or any on-board modules connected to the primary data link. However, certain embodiments may arrange on-board modules on specified data links that have different work machine importance in terms of functionality than other on-board modules.

Modules 130, 132, and 134 represent on-board modules connected to a secondary data link 129 within work machine 120. Secondary data link 129 may be a proprietary or non-proprietary data link. Further, secondary data link 129 may be wireless or wired. The term “secondary data link” is not intended to be limiting. That is, “secondary” refers to a data link for designation purposes only, and does not infer secondary functionality associated with the data link or any on-board modules connected to the secondary data link. However, certain embodiments may arrange on-board modules and interface control system 126 on specified data links that have different work machine importance in terms of functionality than other on-board modules.

On-board modules 122, 124, 130, 132, and 134 may include one or more processing devices and memory devices for storing data executed by the processing devices (all not shown). In one embodiment, on-board modules 122, 124, 130, 132, and 134 may include software that is stored in a rewritable memory device, such as a flash memory. The software may be used by a processing device to control a particular component of work machine 120, such as an engine component. In certain embodiments, the software is modifiable through commands received by the processing devices over respective data links 127 and 129.

Interface control system 126 represents an on-board interface device configured to perform functions consistent with embodiments of the work machine. Interface control system 126 may be configured with various types of hardware and software depending on its application within work machine 120. Thus, in accordance with certain embodiments, interface control system 126 may provide interface capability that facilitates the transmission of data to and from communication module 121 and on-board modules 122, 124, 130, 132, and 134. Further, interface control system 126 performs various data processing functions and maintains data for use by one or more on-board modules or off-board systems. For example, interface control system 126 may be configured to perform protocol conversions (e.g., tunneling and translations) and message routing services for on-board data links.

For clarity of explanation, FIG. 1 depicts interface control system 126 as a distinct element. However, interface control functionality may be implemented via software, hardware, and/or firmware within one or more modules (e.g., 122 and 124) on an on-board data link. Thus, interface control system 126 may, in certain embodiments, represent functionality or logic embedded within another element of work machine 120.

In one embodiment, interface control system 126 may include various computing components used to perform certain functions consistent with the requirements of that embodiment. To do so, interface control system 126 may include one or more processors and memory devices (not shown). For example, interface control system 126 may include a digital core that includes the logic and processing components used by interface control system 126 to perform interface, communications, software update functionalities, and software driver selection. In one embodiment, the digital core may include one or more processors and internal memories. The memories may represent one or more devices that temporarily store data, instructions, and executable code, or any combination thereof, used by a processor. Further, the memories may represent one or more memory devices that store data temporarily during operation of interface control system 126, such as a cache memory, register device, buffer, queuing memory device, and any type of memory device that maintains information. The internal memory used by interface control system 126 may be any type of memory device, such as flash memory, Static Random Access Memory (SRAM), and battery backed non-volatile memory devices.

In operation, the digital core may execute program code to facilitate communications between on-board modules and/or off-board systems. In one embodiment, interface control system 126 may include software that performs protocol conversion operations for converting information associated with one type of data link to another. The conversion operations may include protocol translation and tunneling features.

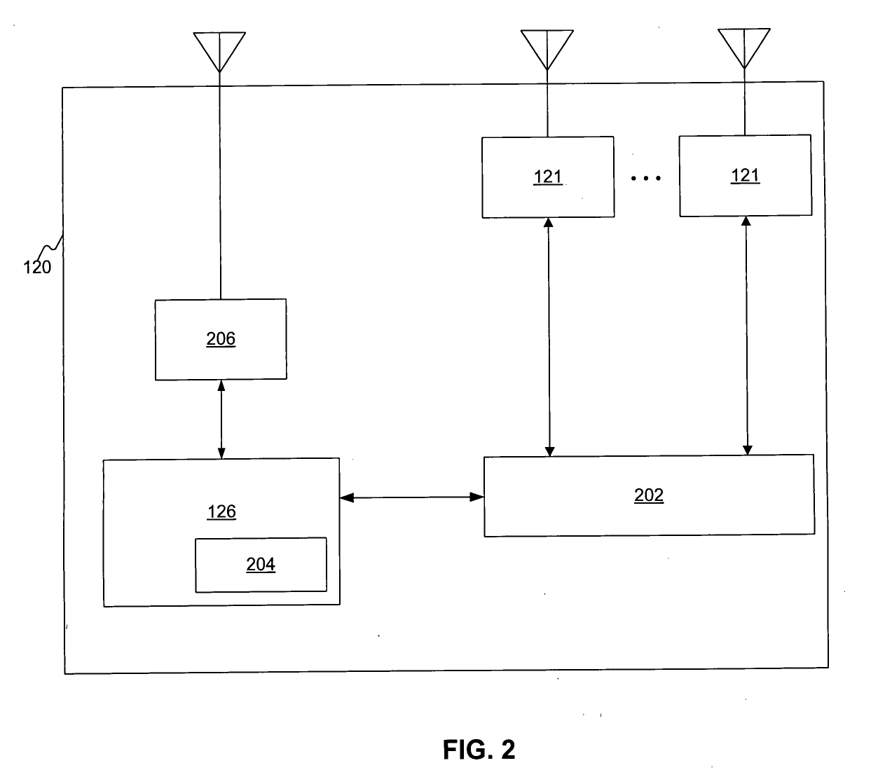

In one embodiment, as shown in FIG. 2, a work machine 120 may include a communication module interface 202 for connecting one or more communication modules 121 to interface control system 126. Communication module interface 202 may include one or more ports (not shown) for connecting a plurality of communication modules 121. The ports may be configured as serial, parallel, Universal Serial Bus (USB), or any other type electronic communication port. The ports may also be configured to received wireless communications, such as infrared communications, from communications modules 121.

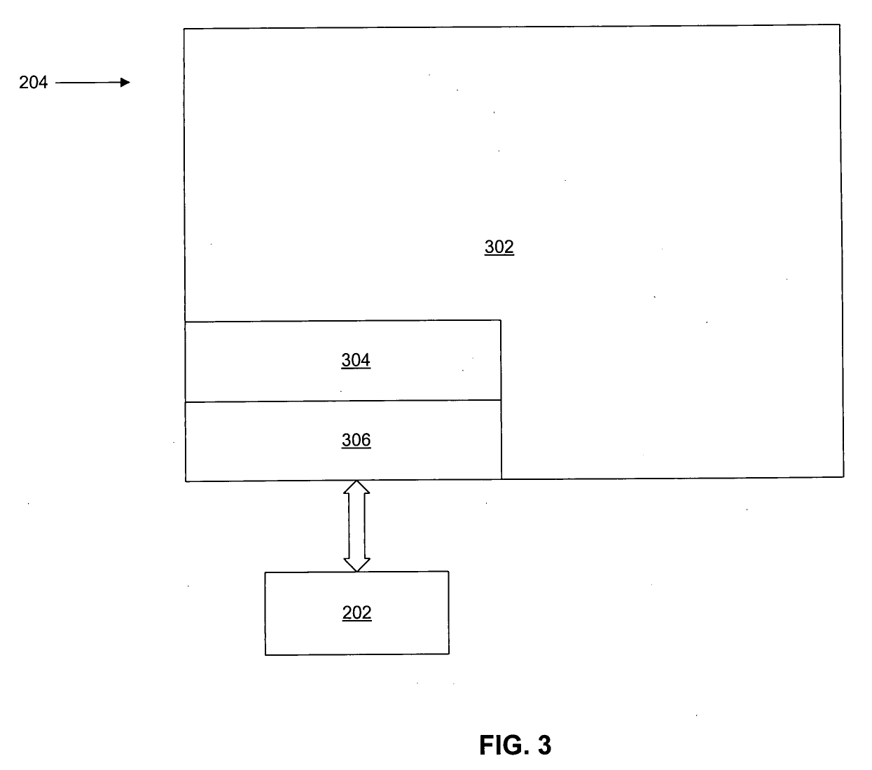

In one embodiment, interface control system 126 includes an electronic component 204 that is used to load appropriate software drivers for operating any communication module 121 connected to communication interface module 202. In certain instances, electronic component 204 may automatically load the drivers upon connection of one or more communication modules 121. FIG. 3 depicts an exemplary embodiment of electronic component 204, which may include an application software section 302, a middleware software section 304, and a communication driver section 306.

Middleware software section 304 may be used to store information regarding the plurality of communication modules 121. The stored information may include the transmission rates and the cost for various transmission channels associated with each of the communication modules 121. Middleware software section 304 may also include an algorithm, which when executed by a processor operating within interface control module 126, determines the most efficient (e.g., fastest rate and/or lowest cost) communication channel, based on the stored information, and selects the appropriate communication module(s) 121.

In one embodiment, electronic component 204 may detect the activation of a switch (not shown) when communication module 121 is connected to interface 202. Based on the activation of the switch, electronic module 204 may select and load an appropriate driver from communication driver section 306 to operate communication module 121.

In another embodiment, the electronic component 204 may receive identification information from communication module 121. This identification information may, for example, identify the model and manufacture of a particular communication module connected to communication interface module 202. Based on the identification, the electronic component 204 may select and load a driver from communication driver section 306 to operate communication modules 121. In addition to the above embodiments, other methods and structures known in the art may be used to detect and/or identify communication modules 121 when connected to interface module 202.

In a further embodiment, once communication module(s) 121 are detected by communication interface module 202, electronic component 204 may load the appropriate software driver from communication module(s) 121, which may store one or more software drivers. The connection of communication module(s) 121 to communication interface module 202 may be through a wireline or wireless communication path (e.g. infrared communications).

In yet a further embodiment, work machine 120 may include an auxiliary communication module 206 (FIG. 2). In the embodiments described above, if the electronic component 204 is unable to retrieve the appropriate driver for operating communication module(s) 121, interface control system 126 may utilize auxiliary communication module 206 to request the appropriate software driver from an external source, such as off-board system 110. Auxiliary communication module 206 may include hardware and/or software that enables the module to send and/or receive data messages through wireline or wireless communications. Alternatively, in such instances where work machine 120 cannot load the appropriate software driver for a connected communication module 121, interface control system 126 may implement a pre-existing communication module 121 that was or is used by machine 120.

As shown in FIG. 2, auxiliary communication module 206 includes one or more wireless antennae for facilitating wireless communications with an external source, such as remote off-board system 110. The wireless communications may include satellite, cellular, infrared, and any other type of wireless communication that enables control system 126 to wirelessly exchange information with an external source, such as off-board system 110.

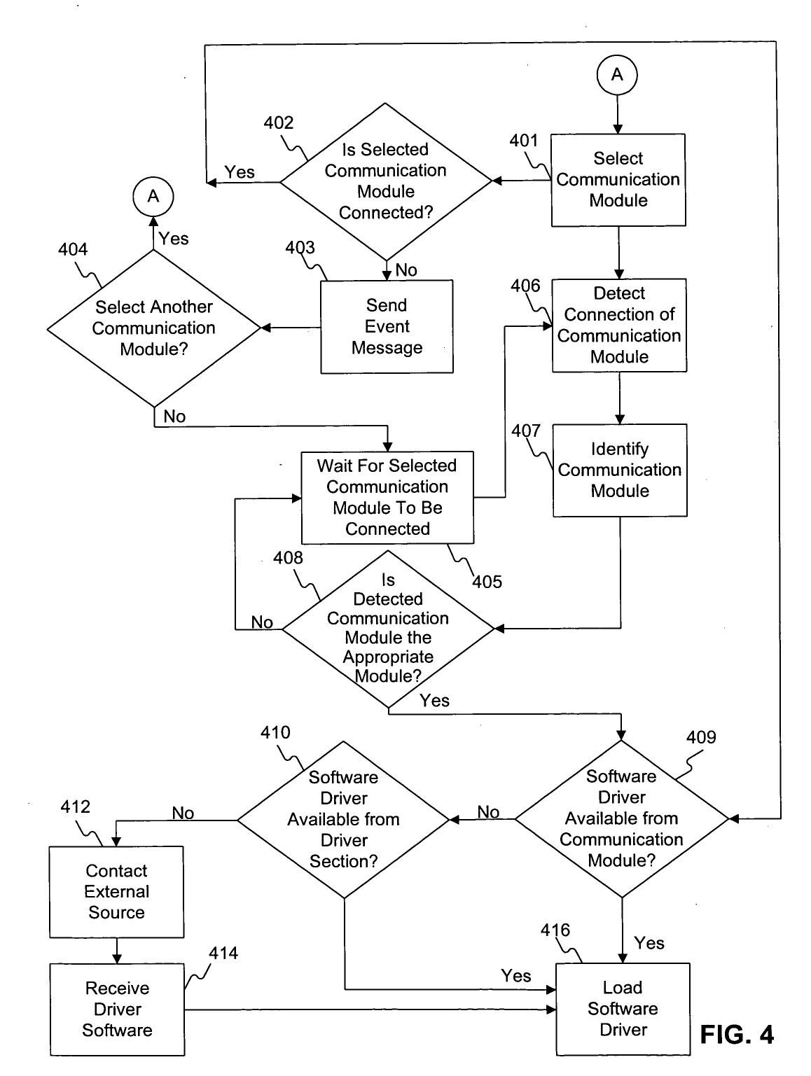

FIG. 4 shows a flowchart of an exemplary process for implementing a plug and play communication module architecture consistent with the disclosed embodiments. Initially, middleware software section 304 may select an appropriate communication module 121 for a particular application (Step 401). The selection may be based on the most efficient communication channel, taking into account information, such as the transmission rates and the cost for various transmission channels associated with each of the communication module(s) 121.

Once the appropriate communication module is selected, electronic component 204 determines whether the selected module is connected to work machine 120 (Step 402). If so, the process proceeds to Step 409 to determine whether the software driver for the selected communication module is available from the module itself. On the other hand, if the selected communication module is not available (Step 402; no) interface control system may execute a process to generate an event message indicating the unavailability of the selected communication module (Step 403). In one embodiment, the event message may be sent to a user (e.g., operator of work machine 120), or another component within work machine. The event message may indicate that there will be a delay in transmission because of the unavailability of the selected communication module.

At Step 404, work machine 120 may determine whether another communication module should be selected. In one embodiment, the decision to select a different communication module may be made by a user or a software process programmed to make such determinations. If a different communication module is to be selected (Step 404; yes), the process returns to Step 401. If, however, another communication module is not to be selected (Step 404; no) electronic component 204 may wait until the appropriate communication module is connected (Step 405).

At some point, electronic component 204 may detect the connection of a communication module(s) 121 to communication interface module 202 (Step 406). In one embodiment, electronic component 204 may detect a switch (not shown) when communication module 121 is connected to interface 202. In another embodiment, the electronic component 204 may receive identification information from communication module(s) 121. This identification information may, for example, identify the model and manufacture of a particular communication module 121.

Once the detected communication module is identified (Step 407), electronic component 204 may determine whether the connected communication module is the appropriate communication module selected in Step 401 (Step 408). If not (Step 408; no), work machine 120 may continue to wait for the appropriate communication module to be selected (Step 405).

On the other hand, if the connected module is the appropriate communication module (Step 408; yes), interface control system 126 determines whether a software driver is available for communication module(s) 121 (Step 409). If the software driver is available, the process proceeds to load the software driver (Step 416). If the software driver is unavailable, electronic component 204 determines whether the software driver is available from communication driver section 306 (Step 410). If the software driver is available, electronic component 204 proceeds to load the software driver (Step 416).

However, if the software driver is unavailable, electronic component 204 may utilize auxiliary communication module 206 to request the appropriate software driver from an external source, such as off-board system 110 (Step 412). Once interface control system 126 receives the software driver through auxiliary communication module 206 (Step 414), the software driver is loaded (Step 416).

### INDUSTRIAL APPLICABILITY

Methods and systems consistent with exemplary disclosed embodiments allow work machines to dynamically connect one or more communication modules in such a manner to efficiently obtain appropriate driver information for the connected modules. Utilizing the disclosed methods and systems, a work machine is operative to accept one or more communication modules. An interface control system within the work machine may select the communication module that is most efficient for a particular environment of, or quality of service required by, the work machine. The selection of the communication module may be based on the most efficient communication channel, taking into account such information as the transmission rates and the cost associated with various transmission channels.

Other embodiments, features, aspects, and principles of the disclosed exemplary systems may be implemented in various environments and are not limited to work site environment. For example, a work machine with an interface control system may perform the functions described herein in other environments, such as mobile environments between job sites, geographic locations, and settings. Further, the processes disclosed herein are not inherently related to any particular system and may be implemented by a suitable combination of electrical-based components. Embodiments other than those expressly described herein will be apparent to those skilled in the art from consideration of the specification and practice of the disclosed systems. It is intended that the specification and examples be considered as exemplary only, with the true scope of the invention being indicated by the following claims.

1. A system utilizing interchangeable communication modules, comprising:
a work machine including:
an interface module for connecting a plurality of communication modules; and
an interface control system including an electronic component connected to said interface module for detecting the connection of at least one of the plurality of communication modules and loading a software driver for operating the at least one of the plurality of communication modules.

2. The system of claim 1, wherein the electronic component includes application software.

3. The system of claim 2, wherein the electronic component includes middleware software.

4. The system of claim 3, wherein the middleware software includes communication module information.

5. The system of claim 3, wherein the electronic component implements the middleware software to select at least one of the plurality of communication modules based on the communication module information.

6. The system of claim 1, wherein the interface module includes a switch for detecting a connection of the at least one of the plurality of communication modules.

7. The system of claim 1, wherein the software driver is stored in a software driver section of the electronic component.

8. The system of claim 1, wherein the electronic component loads the software driver from the at least one of the plurality communication modules.

9. The system of claim 1, wherein the electronic component loads the software driver from an off-board system.

10. The system of claim 1, wherein the electronic component receives an identification code that is used for identifying the at least one of the plurality of communication modules and selecting the software driver.

11. A method for interchanging communication modules, the method performed in a work machine including an interface module and an electronic component, comprising:
connecting the interface module of the work machine to a plurality of communication modules;
connecting the electronic component of the work machine to the interface module;
detecting the connection of the at least one of the plurality of communication modules; and
loading a software driver for operating the at least one of the plurality of communication modules.

12. The method of claim 11, further including application software within the electronic component.

13. The method of claim 12, further including middleware software within the electronic component.

14. The method of claim 13, further including communication module information within the middleware software.

15. The method of claim 14, further including selecting at least one of the plurality of communication modules based on the communication module information.

16. The method of claim 11, wherein detecting the connection further includes using a switch to detect a connection of the at least one of the plurality of communication modules.

17. The method of claim 11, further including loading the software driver from a software driver section of the electronic component.

18. The method of claim 11, further including loading the software driver from the at least one of the plurality of communication modules.

19. The method of claim 11, further including loading the software driver from an external source.

20. The method of claim 19, further including receiving an identification code that is used for identifying the at least one of the plurality of communication modules and selecting the software driver.

21. A system for utilizing interchanging communication modules in a work machine including an interface module and an electronic component, the system comprising:
means for connecting the interface module of the work machine to a plurality of communication modules;
means for connecting the electronic component of the work machine to the interface module;
means for detecting the connection of the at least one of the plurality of communication modules; and
means for loading a software driver for operating the at least one of the plurality of communication modules.

22. The system of claim 21, further including means for storing application software in the electronic component.

23. The system of claim 22, further including means for storing middleware software in the electronic component.

24. The system of claim 23, wherein the stored middleware software includes communication module information.

25. The system of claim 24, further including means for selecting at least one of the plurality of communication modules based on the communication module information.

26. The system of claim 21, further including switch means for detecting a connection of the at least one of the plurality of communication modules.

27. The system of claim 21, wherein the loading means retrieves the software driver from a software driver section of the electronic component.

28. The system of claim 21, wherein the loading means retrieves the software driver from the at least one of the plurality of communication modules.

29. The system of claim 21, further including means for loading the software driver from an external source.

30. The system of claim 29, further including means for receiving an identification code that is used for identifying the at least one of the plurality of communication modules and selecting the software driver.

31. A computer-readable media stored in a work machine having computer executable instructions for performing steps comprising:
a) detecting the connection of at least one of a plurality of communication modules to the work machine;
b) loading a software driver for operating the at least one of the plurality of communication modules from the at least one of the plurality of communication modules;
c) if the software driver is unavailable in the at least one of the plurality of communication modules, loading the software driver from a software driver section of an electronic component; and
d) if the software driver is unavailable in the at least one of the plurality of communication modules and the software driver section, loading the software driver from an external source.

32. The computer-readable media of claim 31, further including instructions for storing application software within the electronic component.

33. The computer-readable media of claim 31, further including instructions for storing middleware software within the electronic component.

34. The computer-readable media of claim 33, wherein storing the middleware software includes storing communication module information.

35. The computer-readable media of claim 34, further including instructions for selecting at least one of the plurality of communication modules based on the communication module information.

36. The computer-readable media of claim 31, further including instructions for receiving an identification code that is used for identifying the at least one of the plurality of communication modules and selecting the software driver.
